(19) United States
(12) Patent Application Publication
(10) Pub. No.: US 2009/0144752 A1
(43) Pub. Date: Jun. 4, 2009

(54) UNMANAGED-TO-MANAGED AGGREGATION

(75) Inventors: Misha Shneerson, Redmond, WA (US); David Andrew Whitechapel, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/947,782

(22) Filed: Nov. 30, 2007

(51) Int. Cl. G06F 13/00

(52) U.S. Cl. 719/316

(57) ABSTRACT

Various technologies and techniques are disclosed for providing communication between managed objects across application domains. When a determination is made that a communication from a first managed object to a second managed object on a different application domain is needed, an unmanaged aggregation object is created. An aggregation process is used to aggregate the second unmanaged object with the unmanaged aggregation object. Calls are then passed from the first managed object through the unmanaged aggregation object to the second managed object. The second managed object appears to be an unmanaged object through use of the unmanaged aggregation object.

### BACKGROUND

Many software applications can be extended with custom functionality. Custom functionality is often provided through an add-in, which is a component that is dynamically discovered and loaded by its host application. An add-in is designed to expand the functionality of the host application beyond what the host application provides standing alone. For example, an add-in might be used from within a word processing program to search the Internet for articles relating to a certain word that was typed within the word processing program. In this example, the host application is the word processing program, and the Internet search tool is the add-in.

Add-ins are typically created as a dynamic link library (DLL) or other program that the host application can load. While each add-in may provide different functionality, there are certain common features that all such add-ins need to support in order for the add-in to operate correctly in the host application. These common features can be built into a set of runtime services.

An increasing number of applications are being written using managed code. The term “managed code” as used herein is meant to include computer program code that executes under the management of a virtual machine. A few examples of virtual machines include MICROSOFT® .NET Framework and Java Virtual Machine (VM). These virtual machines are responsible for providing an extra layer of management and control over software applications, which is intended to help increase security, improve program operation, and provide other enhanced benefits. Managed code is contrasted with unmanaged code, which is executed directly by a computer's central processing unit. In other words, an executable or other program that is based upon unmanaged code is just executed directly by the CPU without the extra layer in between.

Many older applications are written as unmanaged applications, such as MICROSOFT® component object model (COM) applications. It is becoming increasingly common for customers to want to extend upon the functionality of the older unmanaged applications using managed code. There are difficulties involved in integrating an unmanaged application with a managed application. One reason is because there are many differences between unmanaged object models and managed object models. For example, the MICROSOFT® COM model and the MICROSOFT® .NET model have extensive differences in how programs are created, how calls between programs can be performed, and so on.

### SUMMARY

Various technologies and techniques are disclosed for providing communication between managed objects across application domains. When a determination is made that a communication from a first managed object to a second managed object on a different application domain is needed, an unmanaged aggregation object is created. An aggregation process is used to aggregate the second unmanaged object with the unmanaged aggregation object. Calls are passed from the first managed object through the unmanaged aggregation object to the second managed object. The second managed object appears to be an unmanaged object through use of the unmanaged aggregation object.

In another implementation, a method for using COM interop to facilitate communications between managed objects is described. An unmanaged COM aggregation object is created when a first managed object wants to communicate with a second managed object across application domains. The unmanaged COM aggregation object serves as an outer object for the second managed object. Calls are passed from the first managed object to the second managed object through the unmanaged COM aggregation object using COM interop.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of one implementation illustrating the aggregating of an outer unmanaged object with an inner managed object to facilitate calls across application domains.

FIG. 2 is a process flow diagram for one implementation illustrating the stages involved in using an unmanaged aggregation object to allow managed objects to communicate across application domains.

FIG. 3 is a process flow diagram for one implementation illustrating the stages involved in treating a managed object with an unmanaged COM aggregation object according to unmanaged COM object rules.

FIG. 4 is a diagrammatic view of a computer system of one implementation.

### DETAILED DESCRIPTION

The technologies and techniques herein may be described in the general context as an application that provides unmanaged-to-managed aggregation, but the technologies and techniques also serve other purposes in addition to these. In one implementation, one or more of the techniques described herein can be implemented as features within a platform integration program such as MICROSOFT® Visual Studio Tools for Office (VSTO), from within a managed code framework such as MICROSOFT® .NET Framework or Java Virtual Machine, or from any other type of program or service that coordinates the communication between application components.

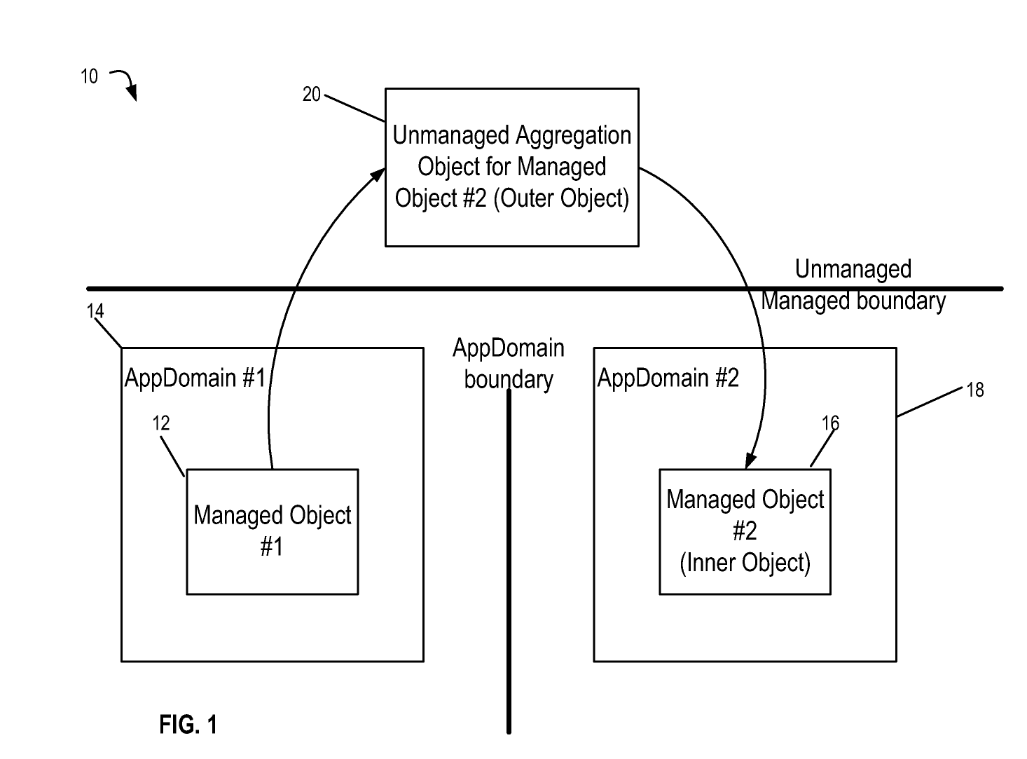

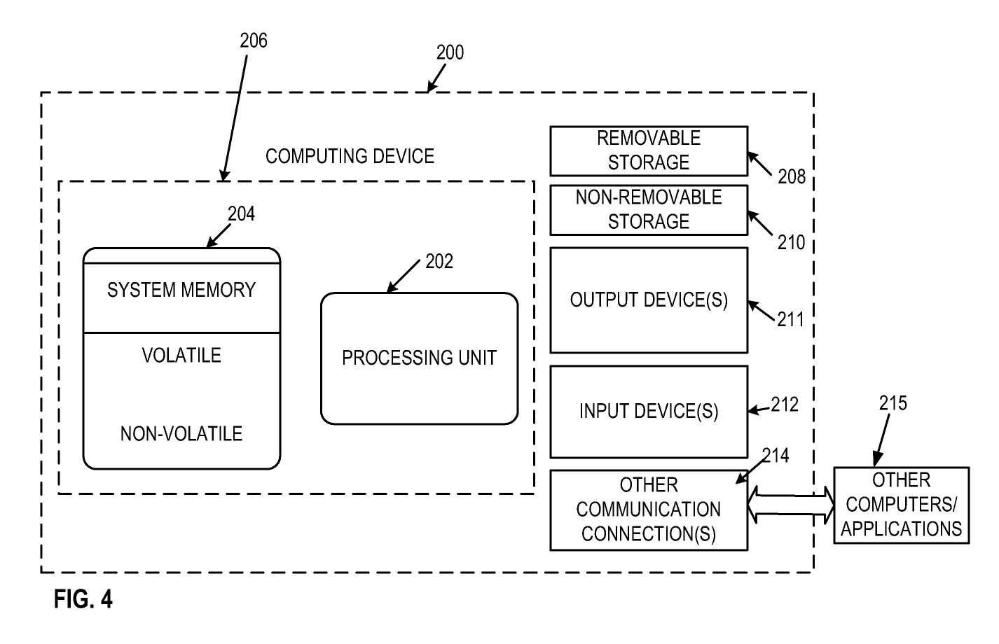

FIG. 1 is a diagrammatic view of one implementation of an aggregation model 10 illustrating the aggregating of an outer unmanaged object with an inner managed object to facilitate calls across application domains. In some implementations, some or all of the features of aggregation model 10 are at least partially implemented in the operating logic of computing device 200 (of FIG. 4). In one implementation, aggregation model 10 is used to facilitate calls between two managed objects across application domains through use of an unmanaged object as described herein. As noted in the background, an unmanaged object is an object that is created using unmanaged code, and is executed directly by a computer's central processing unit. A managed object, on the other hand, is managed by a framework, such as a virtual machine, which then executes the object.

In the example shown in FIG. 1, there are two application domains (14 and 18). The term “application domain” as used herein is meant to include an isolation context in which one or more application components are executed. Suppose that a first managed object 12 in the first application domain 14 wants to call a second managed object 16 in the second application domain 18. A technique called aggregation can be used to create an unmanaged aggregation object 20. The unmanaged aggregation object 20 then becomes the outer object for the inner object in which it exposes, which in this example is the second managed object 16 in the second application domain 18. The term “aggregation” as used herein is meant to include an object reuse mechanism in which an outer object exposes interfaces from an inner object as if they were implemented on the outer object itself. When an outer object aggregates an interface of an inner object, it does not reimplement the interface. Rather, the outer object merely passes the inner object's interface pointer directly to the caller. Thus, in the example shown in FIG. 1, when the first managed object 12 makes a call to the second managed object 16 unmanaged, the call is routed through the unmanaged aggregation object 20. Due to the aggregation, an interface pointer is handed from the inner object (second managed object 16) and back out to the caller (first managed object 12). The aggregation is carefully constructed in such a way that the caller (first managed object 12) sees a consistent set of interfaces in the aggregation, regardless of which interface pointer it is using at any given time.

The terms first, second, etc. are just used for the sake of discussion in the examples herein, and are not meant to imply a required order. They are just used to identify different objects with unique names for the sake of discussion. Furthermore, in other implementations, there can be more than two objects that use some or all of the techniques discussed herein.

An exemplary implementation will be described in further detail to illustrate some of the concepts further. The exemplary implementation discusses how these techniques described in FIG. 1 can be implemented with an integration framework manager such as MICROSOFT® Visual Studio Tools for Office (VSTO), called the VSTO runtime shim in the example herein. As noted in the background, COM components are traditionally developed in unmanaged code. Increasingly, however, add-ins that extend a host application's functionality are being developed in managed code. One purpose of the VSTO runtime is to provide integration between unmanaged host applications and managed add-ins. The VSTO runtime includes both unmanaged and managed components. As an example, unmanaged MICROSOFT® Office host applications can communicate with the unmanaged components in the VSTO runtime. In other words, VSTO helps enable unmanaged COM add-ins to call managed objects in the .NET Framework. These unmanaged VSTO objects then communicate with the managed VSTO components, and these in turn communicate with the managed add-ins.

As noted previously, in aggregation, a caller is provided with a direct pointer to the inner object. In the context of MICROSOFT® Office add-ins, this can imply making a pointer to a managed object directly available to an unmanaged calling application. If this were done without an intercepting runtime shim, this could be a very problematic scenario, which could easily result in all kinds of bad behavior. The add-in might not actually be loaded and available when the host wants to call into it; the add-in might be loaded without security checks; the add-in might be unloaded prematurely; exceptions might propagate from the add-in to the host causing instability; and so on. Therefore, in one implementation, to help avoid some of these issues, a runtime such as the VSTO runtime shim can provide the same proxying services that it does for contained interfaces, but using aggregation.

In the case of the VSTO runtime shim, the aggregating of an inner managed object with an outer unmanaged object is done by using the Marshal.CreateAggregatedObject method in the .NET base class library. In one implementation, this method is a static method on a sealed abstract base class, and can therefore only be used within managed code. For this reason, the VSTO runtime shim first creates an instance of a managed object. This managed object performs the aggregation, and the net result is that the unmanaged VSTO runtime shim is the outer object in the aggregation, and the managed add-in is the inner object. Referring this back to FIG. 1 for further context, that means that in the case of the VSTO hypothetical example described herein, the add-in would be the inner object (the second managed object 16), and the unmanaged aggregation object 20 would be created to allow the first managed object 12 (the VSTO runtime or another object) to make calls to the add-in (the second managed object 16).

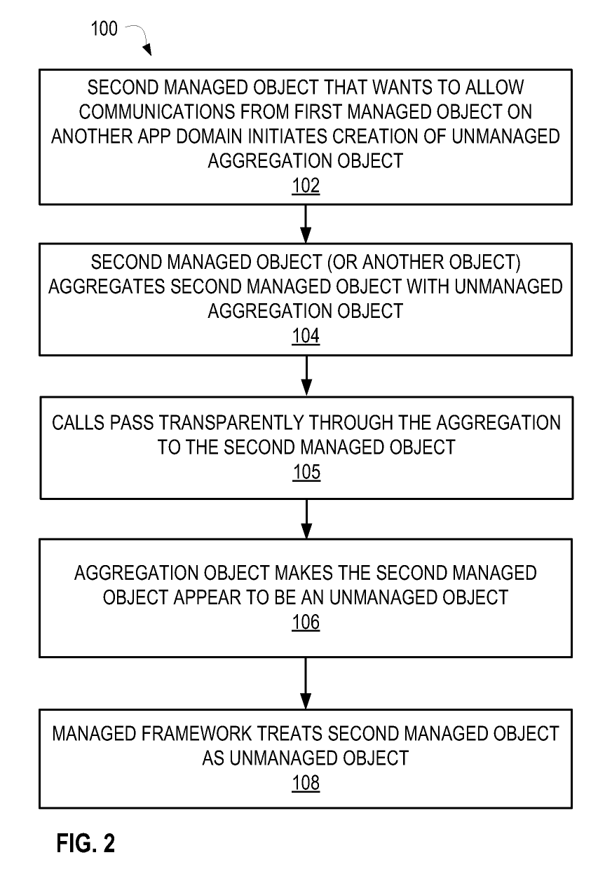

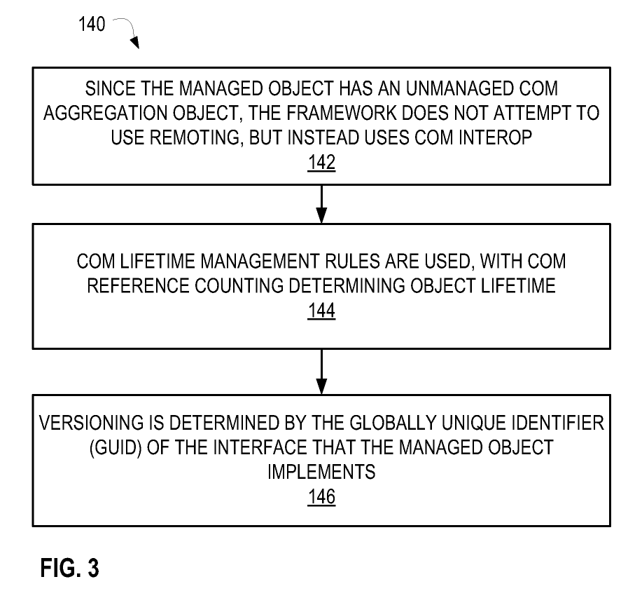

Turning now to FIGS. 2-3 with continued reference to FIG. 1, the stages for implementing one or more implementations of aggregation system 10 are described in further detail. In some implementations, the processes of FIGS. 2-3 are at least partially implemented in the operating logic of computing device 200 (of FIG. 4).

FIG. 2 is a process flow diagram 100 for one implementation illustrating the stages involved in using an unmanaged aggregation object to allow managed objects to communicate across application domains. Suppose there is a first managed object and a second managed object. The second managed object that wants to allow communications from the first managed object on another application domain initiates a process for creating an unmanaged aggregation object (stage 102). In one implementation, the creation of the unmanaged aggregation object is actually initiated by a managed add-in that owns the second managed object. The second managed object (or another object) aggregates (combines) the second managed object with the unmanaged aggregation object (stage 104). Calls pass transparently through the aggregation to the second managed object (stage 105). The aggregation object makes the second managed object appear to be an unmanaged object (stage 106). The managed framework treats the second managed object as an unmanaged object (stage 108).

FIG. 3 is a process flow diagram 140 for one implementation illustrating the stages involved in treating a managed object that has an unmanaged COM aggregation object according to unmanaged COM object rules when performing communication across application domains. This example describes some features that may be specific to COM techniques, but the concepts can apply more generally to other platforms where such platforms have similar features. In other words, this non-limiting example is just provided for the sake of illustration of how some of the concepts can apply to a particular implementation. Furthermore, while FIG. 3 is laid out in the form of a flow diagram, the stages discussed therein are not limited to any particular order.

Suppose that an unmanaged aggregation object is created for a managed object according to some or all of the techniques described earlier. Further suppose that the unmanaged aggregation object is created using COM and the managed object is a MICROSOFT® .NET object. Since the managed object has an unmanaged COM aggregation object, when the aggregated object re-enters the .NET CLR, it appears to be a regular COM object rather than a managed object. Thus, the MICROSOFT® .NET Framework does not attempt to use remoting for communicating across application domains, but instead uses COM interop (stage 142). The term “COM interop” as used herein means a technique which enables .NET managed objects to call COM unmanaged objects and which enables COM unmanaged objects to call .NET managed objects.

In one implementation, the use of COM interop through the unmanaged aggregation object for enabling two managed objects to communicate across application domains provides for simplified communications. The Common Language Runtime (CLR) provided by the MICROSOFT® .NET Framework will not attempt to load the type of the object into the current application domain when making calls on an instance of this object in another application domain, which it would do if it recognized the object as a managed object.

In other words, without using some of the techniques described herein, a technique called remoting would typically be used to make calls across application domains. Remoting is a technique that allows an object (termed remotable object) to be made available across remoting boundaries, which includes different application domains, processes or even different computers connected by a network. A remoting runtime hosts the listener for requests to the object in the application domain of the server application. At the client end, any requests to the remotable object are proxied by the remoting runtime over channel objects. As a result, by instantiating proper channel objects, a remoting application can be made to support different communication protocols without recompiling the application. The runtime itself manages the act of serialization and marshalling of objects across the client and server appdomains.

With remoting, type information for the object being called in the second application domain would typically have to be loaded into the first application domain making the call. In this traditional situation without using the techniques described herein, the CLR might have to load the second object's DLL into the first application domain, even though it will execute the method calls on the second object in the second application domain. This loading typically is done so that remoting can be used to pass parameters across the application domains. The need to load the DLL into the first application domain (purely to read the type information, not to execute it) can be a significant overhead in time and memory usage. Thus, by instead using an unmanaged aggregation object with some of the techniques described herein, remoting can be avoided altogether, and thus some of these issues avoided.

By using the unmanaged COM aggregation object, COM lifetime management rules are used, with COM reference counting determining object lifetime (stage 144). This means that the CLR will not subject the object to .NET's mechanism of lifetime leases, but rather will use COM reference counting.

In other words, without using some of the techniques discussed herein, virtual machines would typically manage the lifetime of the objects using lease-based object lifetime management. In such a scenario, this means that leases need to be explicitly set up in a remoting-based scenario or the second managed object may be destroyed even though it is referenced by a remoting channel in another application domain. Using an unmanaged aggregation object as described herein, the managed add-in appears to be a COM object, and therefore deterministic COM object lifetime rules are used (instead of the lease-based lifetime management approach).

By using the unmanaged COM aggregation object, versioning is determined by the globally unique identifier (GUID) of the interface that the managed object implements (stage 146). If the CLR recognized the object as a managed object, the version for such an object would have depended on the version of the assembly it is defined in.

In other words, without using some of the techniques herein, versioning could introduce potential issues between two managed objects. Suppose, for example, that component C1 in application domain A1 talks to component C2 in application domain A2, and it uses interface T1 to communicate. Later, the DLL that contains C2 is updated, but interface I1 is not changed. In the .NET world, changing the assembly version means that all the types (classes and interfaces) in the assembly are also a different version. In the COM world, if the interface I1 has not changed, and its GUID has not changed, then it is not a different version—regardless of the fact that the DLL has changed. By using an unmanaged aggregation object with the techniques described herein, COM rules can instead be used for versioning, which can be easier to deal with than .NET rules.

In one implementation, the model described herein using unmanaged-to-managed aggregation is more lightweight than one or more alternative models, such as the MICROSOFT® Managed Add-In Framework (MAF). For example, one implementation of the MAF model may use an extensive number of library DLLs to support the infrastructure, which are not needed in the unmanaged-to-managed aggregation model described herein.

As shown in FIG. 4, an exemplary computer system to use for implementing one or more parts of the system includes a computing device, such as computing device 200. In its most basic configuration, computing device 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 4 by dashed line 206.

Additionally, device 200 may also have additional features/functionality. For example, device 200 may also include additional storage (removable and/or non-removable) including, but not limited to, magnetic or optical disks or tape. Such additional storage is illustrated in FIG. 4 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 200. Any such computer storage media may be part of device 200.

Computing device 200 includes one or more communication connections 214 that allow computing device 200 to communicate with other computers/applications 215. Device 200 may also have input device(s) 212 such as keyboard, mouse, pen, voice input device, touch input device, etc. Output device(s) 211 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
when a determination is made that a communication from a first managed object to a second managed object on a different application domain is needed, creating an unmanaged aggregation object; and
passing calls from the first managed object through the unmanaged aggregation object to the second managed object.

2. The computer-readable medium of claim 1, wherein creation of the unmanaged aggregation object is initiated by the second managed object.

3. The computer-readable medium of claim 1, wherein the unmanaged aggregation object is created as a COM object.

4. The computer-readable medium of claim 3, wherein the unmanaged object uses COM interop to allow the first managed object to communicate with the second managed object.

5. The computer-readable medium of claim 1, wherein the unmanaged aggregation object is operable to make the second managed object appear to be an unmanaged object.

6. The computer-readable medium of claim 1, wherein a managed framework that manages the first managed object and the second managed object treats the second managed object as an unmanaged object due to the unmanaged aggregation object.

7. The computer-readable medium of claim 1, wherein the unmanaged aggregation object is an outer object.

8. The computer-readable medium of claim 1, wherein the second managed object is an inner object.

9. A method for facilitating communications between managed objects residing on separate application domains comprising the steps of:
using an aggregation process to create an unmanaged aggregation object for allowing a first managed object on a first application domain to communicate with a second managed object on a second application domain, the aggregation process serving to aggregate the second unmanaged object with the unmanaged aggregation object;
passing calls from the first managed object through the unmanaged aggregation object to the second managed object; and
making the second managed object appear to be an unmanaged object through use of the unmanaged aggregation object.

10. The method of claim 9, wherein the second managed object is an add-in.

11. The method of claim 10, wherein the first managed object is an application that wishes to communicate with the add-in.

12. The method of claim 10, wherein the first managed object is an integration framework manager that facilitates communication between objects.

13. The method of claim 9, wherein the calls are passed from the first managed object to the second managed object using COM interop.

14. The method of claim 9, wherein by using the unmanaged aggregation object, communication occurs between the first application domain and the second application domain without using remoting.

15. The method of claim 9, wherein the unmanaged aggregation object is an outer object.

16. The method of claim 9, wherein the second managed object is an inner object.

17. A method for using COM interop to facilitate communications between managed objects comprising the steps of:
creating an unmanaged COM aggregation object when a first managed object wants to communicate with a second managed object across application domains, the unmanaged COM aggregation object serving as an outer object for the second managed object; and
passing calls from the first managed object to the second managed object through the unmanaged COM aggregation object using COM interop.

18. The method of claim 17, wherein a managed framework that manages the first managed object and the second managed object treats the second managed object as an unmanaged COM object due to the unmanaged COM aggregation object.

19. The method of claim 18, wherein the second managed object is managed using COM lifetime management rules.

20. The method of claim 18, wherein versioning is determined by a globally unique identifier of an interface that the second managed object implements.
